(19) United States
(12) Patent Application Publication
(10) Pub. No.: US 2007/0220194 A1
(43) Pub. Date: Sep. 20, 2007

(54) SYSTEM FOR COVERTLY STORING CONTROL INFORMATION

(75) Inventor: Pope Ijtsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,510

(22) PCT Filed: Jun. 9, 2005
(86) PCT No.: PCT/IB05/51906

§ 371 Date: Dec. 13, 2006

(30) Foreign Application Priority Data
Jun. 21, 2004 (EP) 04102835.8

(51) Int. Cl. G06F 3/06

(52) U.S. Cl. 711/4

(57) ABSTRACT

A device for recording records blocks of information on logical addresses on a record carrier at corresponding physical addresses. The logical addresses are translated into the physical addresses in dependence of remapping information (57) indicative for translating a logical address initially mapped to a physical address to an alternate physical address in a remapping area (55), for example for defect management or logical overwrite. The device has storage means for covertly storing control data (54) while maintaining a size of the user area (53), the storage means being arranged for assigning a covert physical address to the control data and adapting the remapping information (57) to indicate that the covert physical address is not available for storing user data.

The invention relates to a device for recording information in blocks having logical addresses in a user area on a record carrier, which device comprises recording means for recording marks in a track on the record carrier representing the information.

The invention further relates to a device for reading information in blocks having logical addresses in a user area on a record carrier, which device comprises reading means for reading marks in a track on a record carrier representing the information.

The invention further relates to a method of storing control information for use in recording information in blocks having logical addresses in a user area.

The invention further relates to a computer program product for storing control information for use in recording information.

The invention relates to the field of information storage, and therein to storing control information without affecting the storage capacity of a user data area on a record carrier, and, in a particular case, to storing variable amounts of control information related to digital rights management.

A device and method for recording information on a record carrier are known from US 2003/0159037. The document relates to optical record carriers such as CD or DVD. Optical recording devices have recording means for recording the information in information blocks having logical addresses on a disc at corresponding allocated physical addresses. The document describes managing and storing control data for digital rights management (DRM), and in particular protecting content recorded thereon by cryptographical methods. For reproducing the protected content control data is required, e.g. decryption keys. The document describes that such secret control data is recorded and retrieved via a dedicated secret-information recording/playback circuit, which is only available in so-called valid devices. Such dedicated circuits allow storage of secret control data in a so called hidden channel, i.e. physically different from the normal storage of data. Alternatively such control data may be stored in special areas, e.g. in the lead-in or lead-out areas of a record carrier.

A problem of the known system of recording is that dedicated recording and retrieving circuits are required for storing the control data in the hidden channel.

It is an object of the invention to provide a system of storing control data that facilitates storing control data without requiring a hidden channel or special reserved areas.

For this purpose, the device for recording as described in the opening paragraph comprises control means for controlling the recording by locating each block at a physical address in the track, which control means comprise addressing means for translating the logical addresses into the physical addresses and vice versa in dependence on remapping information, remapping means for managing the remapping information relating to at least one remapping area, the remapping information being indicative for translating a logical address initially mapped to a physical address in the user data area to an alternate physical address, storage means for covertly storing control data while maintaining a size of the user area, the storage means being arranged for assigning a covert physical address to the control data and adapting the remapping information to indicate that the covert physical address is not available for storing user data.

For this purpose, the device for reading as described in the opening paragraph comprises control means for controlling the reading by locating each block at a physical address in the track, which control means comprise addressing means for translating the logical addresses into the physical addresses and vice versa in dependence on remapping information relating to at least one remapping area, the remapping information being indicative for translating a logical address initially mapped to a physical address in the user data area to an alternate physical address, recovery means for retrieving covertly stored control data from a covert physical address in dependence on the remapping information indicating that the covert physical address is not available for storing user data.

For this purpose, the method of storing information as described in the opening paragraph is for use in recording information in blocks having logical addresses in a user area, which recording comprises translating the logical addresses into the physical addresses and vice versa in dependence on remapping information, and managing the remapping information relating to at least one remapping area, the remapping information being indicative for translating a logical address initially mapped to a physical address in the user data area to an alternate physical address, the method comprising covertly storing control data while maintaining a size of the user area by assigning a covert physical address to the control data and adapting the remapping information to indicate that the covert physical address is not available for storing user data.

The measures have the effect that control data is stored using storage capacity assigned to system remapping use, e.g. defect management or logical overwrite. Hence no hidden channel or special reserved area is needed, while sharing the capacity already assigned to system use has the advantage that the storage capacity for the user is not influenced. In addition, the control data cannot be manipulated via a pre-existing, standard device, because the remapping information has been adapted to indicate that the physical address is not available for user data. Advantageously the standard device will avoid changing or accessing the physical address that covertly stores the control data.

The invention is also based on the following recognition. The inventors have seen that a problem of recording control data also occurs when control data is accommodated in the user data area. Although control data may be formatted like other data, e.g. stored in a file, such way of storing control data is open to manipulation by any type of device. Moreover, storing the control data in the user area affects the size of the storage capacity for user data. Alternatively a special area of the record carrier may be reserved for control data, and may be made inaccessible to a standard device. For example defect management areas (DMA) for DVD+RW are located in the lead in and in the lead out. Mostly such administration data blocks are not located in the user area, because this limit the available user space and most file systems cannot handle a logical user space that can vary in size or which is not linear, i.e. interrupted by control data that has been inserted not via the file system. Note that the size of such reserved system space must be sufficient to hold the maximum amount of control data that may be expected. The large amount of reserved space may remain unused in many practical situations. The inventors have seen that via remapping mechanisms an area of the disc has already been reserved for system use, i.e. not directly accessible to the user. Storing of variable amounts of control data via the remapping mechanism, and subsequently adapting the remapping tables, provides a flexible storage mechanism for hiding control data without affecting the user data space. Finally this solves the following dilemma. In some cases the specification of a recording format is already closed and all the reserved areas in the lead in or lead out are defined, but a new function needs to be added which needs a kind of control data storage without blocking backwards compatibility. In most cases the constraint is: do not change the recording format. The covert storage according to the invention complies with that constraint. An example of such a feature is at a later time providing tools to implement copy protecting and digital rights management.

In an embodiment of the recording device the storage means are arranged for selecting the covert physical address at a free logical address in the user area and for adapting the remapping information to indicate that the physical address corresponding to the free logical address needs remapping. This has the advantage that the control data is actually stored in the user area, and may be retrieved by a physical reading operation that directly reads physical addresses in the user area. Such physical reading operation may be provided anyway is a standard device for playback of real-time data such as video to comply with timing constraints of the real-time data. The physical reading operation reads the physical address in the user areas and skips retrieving replacement blocks from remapping areas.

In an embodiment of the recording device the storage means are arranged for selecting the covert physical address at a free physical address in the remapping area and for adapting the remapping information to indicate that the free physical address in the remapping area is unusable for remapping. This has the advantage that the control data is stored at a selectable location in the remapping area, and the user area is not affected at all.

In an embodiment of the recording device the remapping means are arranged for accommodating logical overwrite of previous user data by new user data on an occupied logical address in the user area of a write-once record carrier by remapping the occupied logical address to an alternate physical address in a remapping area for containing the new user data. This has the advantage that on write once media a random overwrite function is provided. The storage of control data can advantageously be accommodated using the overwrite function. In a particular embodiment the storage means are arranged for selecting the covert physical address at a free physical address in the remapping area via the remapping means by requesting the control data to be stored at the occupied logical address, while managing the remapping information to indicate that the physical address originally corresponding to the occupied logical address still contains the user data.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

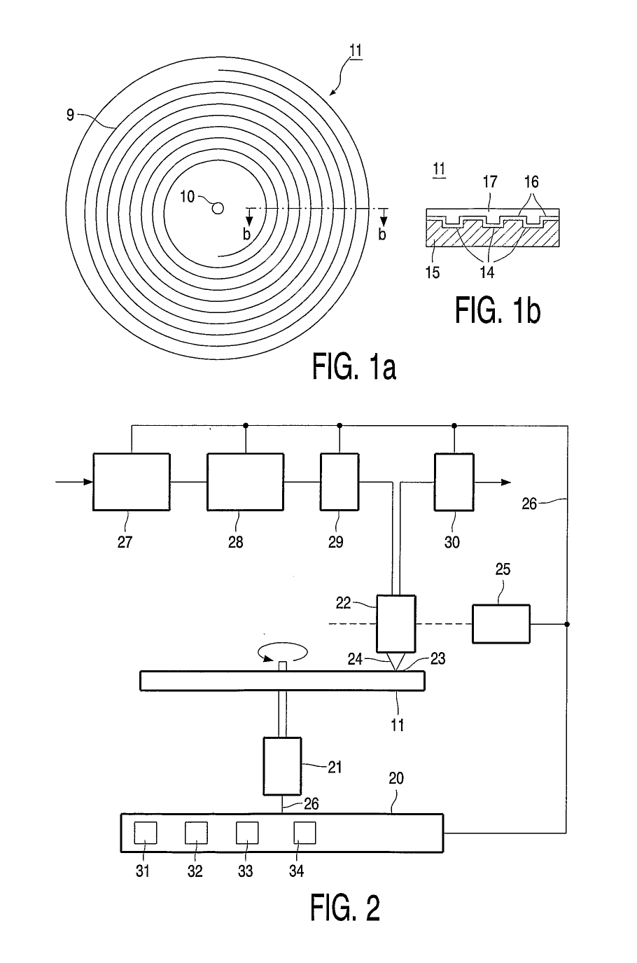

FIG. 1a shows a record carrier (top view),

FIG. 1b shows a record carrier (cross section),

FIG. 2 shows a recording device having a covert control data storage function,

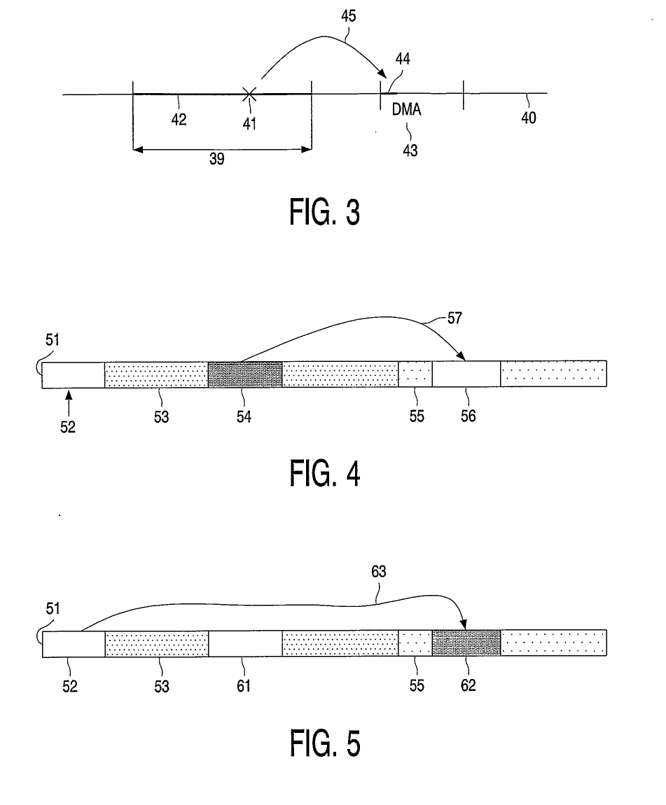

FIG. 3 shows remapping of defective locations,

FIG. 4 shows covertly storing control data via remapping of user data, and

FIG. 5 shows covertly storing control data in a remapping area.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-RW, and rewritable versions of DVD, such as DVD+RW, and the high density writable optical disc using blue lasers, called Blu-ray Disc (BD). Further details about the DVD disc can be found in reference: ECMA-267: 120 mm DVD—Read-Only Disc—(1997). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 in FIG. 1b which enables a read/write head to follow the track during scanning. The track structure comprises position information including so-called physical addresses, for indicating the location of units of information, usually called information blocks. The position information includes specific synchronizing marks for locating the start of such information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying digital information in blocks under control of a file management system. The information may include real-time information to be recorded and reproduced continuously, in particular information representing digitally encoded video according to a standardized format like MPEG2.

An example of control data to be covertly stored according to the invention is as follows. In a content protection system cryptographic keys are used for preventing unlimited access to and copying of the content. The main key may be stored in hidden location, or using a hidden channel. The Hidden Key in the disc cooperates with an additional data structure called the Keylocker. The Hidden Key is located outside the user area and is a fairly small area, which can be easily added to for example the BD R lead-in. The Keylocker is the data structure that holds DRM information that can be opened by the key from the Hidden Channel. The Keylocker can contain information about the contents on the disc. For example the encryption key for the data on the disc, the digital rights management information per track or per session, on how many times tracks can be played back, or the secret key to allow an application to work with the disc. The Keylocker may require updating when for example the user has played the track or new content is added with new rights or the user has bought new rights. The problem in prior art recording formats is that there is no space available in the lead in or lead out area and it is also unknown how many times this needs to happen. The invention below solves this problem, in particular for Write Once media, by writing the control data to a covert physical address without changing the user size of the disc.

FIG. 2 shows a recording device having a covert control data storage function. The device is for writing information on a record carrier 11 of a type which is writable or re-writable, for example CD-R or CD-RW, or DVD+RW or BD. The device is provided with recording means for scanning the track on the record carrier which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an (optional) input unit 27, and a formatter 28 and a modulator 29. During the writing operation, marks representing the information are formed on the record carrier. The marks are formed by means of the spot 23 generated on the recording layer via the beam 24 of electromagnetic radiation, usually from a laser diode. Digital data is stored on the record carrier according to a predefined data format. Writing and reading of information for recording on optical disks and formatting, error correcting and channel coding rules are well-known in the art, e.g. from the CD and DVD system.

The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

The formatter 28 is for adding control data and formatting and encoding the data according to the recording format, e.g. by adding error correction codes (ECC), interleaving and channel coding. Further the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed to the modulator 29, which generates a laser power control signal which drives the radiation source in the optical head. The formatted units presented to the input of the modulation unit 29 comprise address information and are written to corresponding addressable locations on the record carrier under the control of control unit 20.

The control unit 20 is arranged for controlling the recording by locating each block at a physical address in the track, and for remapping as described below. The control unit includes the following cooperating units: an addressing unit 31, a remapping unit 32, a storage unit 33, and a retrieval unit 34, which units are for example implemented in firmware.

In an embodiment the recording device is a storage device only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1, and for video in the MPEG2 standard. The input unit 27 processes the audio and/or video to units of information, which are passed to the formatter 28. The read processing unit 30 may comprise suitable audio and/or video decoding units.

A read device has the same elements as the recording device, except the specific recording elements, e.g. the read device does not have the input unit 27, the formatter 28 and the modulator 29, and the remapping unit 32 and the storage unit 33.

The addressing unit 31 is for translating physical addresses into logical addresses and vice versa in dependence of remapping information. The logical addresses constitute a contiguous user data storage space to be used for storing sequences of information blocks, such as files under control of a file management system, for example UDF. The remapping unit 32 is for managing the remapping information relating to at least one remapping area, e.g. for creating, updating and storing suitable tables of remapping information. The remapping information is indicative for translating a logical address initially mapped to a physical address in the user data area to an alternate physical address, which alternate physical address may be located in a dedicated and separate spare area, or may be provided locally by adapting the mapping of higher logical addresses (usually called slipping). The storage unit 33 is for covertly storing control data while maintaining a size of the user area. When control data needs to be stored, the storage unit assigns a physical address to the control data and stores the control data at that physical address. To hide that physical address from other processes, i.e. to create a covert physical address, the storage unit adapts the remapping information to indicate that the covert physical address is not available for storing user data.

In particular in the read device (and usually also in the recording device) the control unit includes the retrieval unit 34 for retrieving covertly stored control data from a covert physical address. The retrieval unit is arranged for detecting the covert physical addresses, e.g. from a special remapping table or a special status code assigned to remapping entries. The covert storage location may be known from other control data, or may be preset to predefined physical address locations for specific applications. Note that the retrieval unit may detect that the remapping information indicates that the some physical addresses are not available for storing user data, whereas such addresses are not defect, e.g. are not listed in defect lists.

In an embodiment the retrieval unit 34 is arranged for retrieving the covertly stored control data by reading a range of physical addresses including the covert physical address. Note that the remapping information indicates that the covert physical address does not contain valid data, but the retrieval unit purposely bypasses this remapping or defect information, because the physical address is known to contain valid control data, e.g. from a received command or covert mapping tables.

In an embodiment the remapping unit 32 is a defect management unit which detects defects, for example by monitoring the signal quality of a read-out signal from the head 22 during recording and/or reading. The defects may also be detected by determining an error rate in retrieved information blocks. The defect management unit maintains the defect management information in defect management areas on the record carrier, for example in defect lists as defined for the DVD recordable systems like DVD+RW. The defect management information at least includes remapping information.

FIG. 3 shows remapping of defective locations. A physical address space 40 is schematically represented by a horizontal line. A series of blocks 42 is to be recorded in an allocated physical address range 39. However a defect 41 interrupts the allocated physical address range. Remapping 45 is the process that a block 44 having a logical address corresponding to the physical address 41 that is defective is stored in an alternative physical address in a defect management area (DMA) 43. The remapping information provides data for translating the logical address initially mapped to a physical address exhibiting a defect to an alternate physical address in a defect management area, for example an entry in a secondary defect list including the logical address of the remapped block and its corresponding physical address. Alternatively remapping information may include data for translation of a physical address of a defect to a different physical address in a defect management area.

The defect management areas are located on the record carrier according to a recording area layout. In the layout physical address are assigned a specific logical address of a user data area, or to a defect management area or system area, etc. The layout may be predefined, or may be defined according to parameters included in the system area. The defect management information may include assignment information indicative of assignment of physical addresses in first parts of the track to at least one user data area, assignment of physical addresses in second parts of the track to defect management areas, and assignment of the defect management information to the defect management areas. The assignment of the defect management information to the defect management areas indicates the use of the defect management area, for example a primary defect list and a secondary defect list, or replacement area for a specific type of defects.

In an embodiment the remapping unit 32 is a logical overwrite unit. On a write-once record carrier like DVD-R data that has been recorded cannot be changed. For accommodating logical overwrite of previous user data by new user data remapping is used to assign a free physical address in a spare area to an occupied logical address in the user area. Hence by remapping the occupied logical address to an alternate physical address in a remapping area the new user data can be recorded logically on the same logical address. An example of a system of logical overwrite is described in the document W02004/029968 “Methods and devices for defect and reallocation management on write-once media”. The storage unit 33 now is arranged for storing the control data at a physical address corresponding to a selected logical address, and the remapping information is adapted to indicate that the selected logical address has been remapped to a new physical address. Note that the remapping information tables may indicate that the original physical address does contain different data, or is defective or otherwise unusable. Further on a write-once medium it is necessary to select an un-used, free logical address in the user area, and only adapt the remapping tables to indicate that a next user data write to that logical address needs to be at the new physical address.

In particular the storage unit 33 may be arranged for selecting the covert physical address to a free physical address in the remapping area via the logical overwrite unit using the remapping facilities thereof. First a request is given for the control data to be stored at an occupied logical address. Subsequently the remapping unit will select a physical address for receiving the new data. Next the storage unit takes care that the remapping information indicates that the physical address originally corresponding to the occupied logical address still contains the user data, while the remapping is adapted to indicate that the selected physical address is no longer available for use for remapping for logical overwrite.

FIG. 4 shows covertly storing control data via remapping of user data. A recordable area 51 of a record carrier is schematically shown, and is accessible via physical addresses. The recording area is logically subdivided and starts with a lead-in 52, followed by a user area 53 and a spare area 55. The recording area may be terminated by a lead-out (not shown). Note that in practice the location of the spare area 55 may be different, or several spare areas may be included. For example a inner spare area (ISA) may be located at an inner radial position immediately after the lead-in area, whereas an outer spare area (OSA) may be located at an outer radial position just before the lead-out area. In addition, on multilayer discs, each layer may have one or more spare areas. Note that the total amount of spare area may be a substantial part of the total data storage area of the record carrier, e.g. 50%, allowing managing a large amount of defects or overwrites, and via the current invention, control data or control data updates.

Control data 54 has been recorded in the user area on a so-called covert physical address, which is hidden as follows. Remapping information 57 indicates that the logical address initially corresponding to the (now covert) physical address has been remapped to a new location 56 for containing any user data recorded at that logical address. Note that the lead-in 52 may contain an updated defect list which contains a replacement entry for this logical address or physical address.

In a practical embodiment keylocker information or other specific control data is written in the user area with a write command, and after that the written area is declared defect in the defect tables. Any new write to the same location leads to a replacement and the (new) user data is physically written in the replacement address. The original location contains the keylocker information and the replacement locations contain the normal user data of the application, a shown in FIG. 4. The next time that the application is requesting the written user data the data from the replacement location is returned. Note that an application which is aware of the covertly stored control data can retrieve the keylocker information with a special read command that directly reads the physical address (sometimes called a streaming read because it is intended for reading real-time data).

Note that this solution requires that drive implementations are prohibited to check the quality of the replaced blocks and decide to clear the defect entry for the logical address that contains the control data. Obviously this method can only be used on addresses on the disc that are not yet written.

FIG. 5 shows covertly storing control data in a remapping area. Like in FIG. 4 a recordable area 51 of a record carrier is schematically shown, and starts with a lead-in 52, followed by a user area 53 and a spare area 55. Control data 62 has been recorded in the remapping or spare area 55 on a covert physical address, which is still free, and hidden as follows. Remapping information 63 indicates that the (now covert) physical address is unusable, i.e. cannot be used for remapping. Ordinary user data 61 may be stored on its original location in the user area. Note that, in a defect list in the lead-in, an replacement entry originally assigned to the logical address of user data 61 may now be changed to indicate that the replacement physical address is defect.

In a practical embodiment keylocker information or other specific control data is directly written in the spare area. This can be achieved in two ways. In a first embodiment the control data is written via a special command directly to a free replacement address. This replacement address is declared unusable in the defect table to prevent overwrite or reuse of the physical address. In a second embodiment the control data is written to an already written location of the disc, i.e. the logical address is already occupied by user data. Due to a logical overwrite capability of the drive a replacement will occur because this location is already occupied, and automatically the control data is written in the replacement area. Subsequently the replacement table has to be adapted to set this replacement address to the unusable state so that it not used for another replacement. Further the original overwrite command would update the physical address assigned to the last version of the user data, and now this update is prevented, because the original user data 61 is still valid.

It is noted that the function of the storage unit 33 and the retrieval unit 34 can be performed as a process of storing control data in a separate device, for example as a computer program in a host computer controlling a disc drive. The drive accommodates physically recording and retrieving of information in blocks having logical addresses on the record carrier by locating each block at a physical address in the track, translating the logical addresses into the physical addresses and vice versa in dependence of remapping information.

Although the invention has been explained mainly by embodiments using a DVD+RW or BD defect management system, and using a logical overwrite system for a write-once medium, similar remapping systems used for other types of record carriers are suitable for applying the invention. Also for the information carrier an optical disc has been described, but other media, such as a magnetic hard disc, can be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information in blocks having logical addresses in a user area on a record carrier, which device comprises
recording means (22) for recording marks in a track on the record carrier representing the information, and
control means (20) for controlling the recording by locating each block at a physical address in the track, the control means comprising
addressing means (31) for translating the logical addresses into the physical addresses and vice versa in dependence on remapping information,
remapping means (32) for managing the remapping information relating to at least one remapping area, the remapping information being indicative for translating a logical address initially mapped to a physical address in the user data area to an alternate physical address, and
storage means (33) for covertly storing control data while maintaining a size of the user area, the storage means being arranged for assigning a covert physical address to the control data and adapting the remapping information to indicate that the covert physical address is not available for storing user data.

2. Device as claimed in claim 1, wherein the storage means (33) are arranged for storing the control data comprising digital rights management data.

3. Device as claimed in claim 1, wherein the storage means (33) are arranged for selecting the covert physical address at a free logical address in the user area and for adapting the remapping information to indicate that the physical address corresponding to the free logical address needs remapping.

4. Device as claimed in claim 3, wherein said adapted remapping information indicates a defect at the covert physical address corresponding to the free logical address.

5. Device as claimed in claim 1, wherein the storage means (33) are arranged for selecting the covert physical address at a free physical address in the remapping area and for adapting the remapping information to indicate that the free physical address in the remapping area is unusable for remapping.

6. Device as claimed in claim 1, wherein the remapping means (32) are arranged for accommodating logical overwrite of previous user data by new user data on an occupied logical address in the user area of a write-once record carrier by remapping the occupied logical address to an alternate physical address in a remapping area for containing the new user data.

7. Device as claimed in claim 6, wherein the storage means (33) are arranged for selecting the covert physical address at a free physical address in the remapping area via the remapping means by requesting the control data to be stored at the occupied logical address, while managing the remapping information to indicate that the physical address originally corresponding to the occupied logical address still contains the user data.

8. Device as claimed in claim 1, wherein the remapping means (32) are arranged for accommodating defect management in the user area by remapping a physical address that has a defect to an alternate physical address for containing the content of the defect physical address.

9. Device for reading information in blocks having logical addresses in a user area on a record carrier, which device comprises
reading means (30) for reading marks in a track on a record carrier representing the information,
control means (20) for controlling the reading by locating each block at a physical address in the track, the control means comprising
addressing means (31) for translating the logical addresses into the physical addresses and vice versa in dependence on remapping information relating to at least one remapping area, the remapping information being indicative for translating a logical address initially mapped to a physical address in the user data area to an alternate physical address, and
retrieval means (34) for retrieving covertly stored control data from a covert physical address in dependence on the remapping information indicating that the covert physical address is not available for storing user data.

10. Device as claimed in claim 9, wherein the retrieval means (34) are arranged for retrieving the control data comprising digital rights management data.

11. Device as claimed in claim 9, wherein the retrieval means (34) are arranged for said retrieving the covertly stored control data by reading a range of physical addresses including the covert physical address whereas the remapping information indicates that the covert physical address does not contain valid data.

12. Method of storing control information for use in recording information in blocks having logical addresses in a user area, which recording comprises
locating each block at a physical address in a track on a record carrier,
translating the logical addresses into the physical addresses and vice versa in dependence on remapping information, and
managing the remapping information relating to at least one remapping area, the remapping information being indicative for translating a logical address initially mapped to a physical address in the user data area to an alternate physical address, the method comprising
covertly storing control data while maintaining a size of the user area by
assigning a covert physical address to the control data and
adapting the remapping information to indicate that the covert physical address is not available for storing user data.

13. Computer program product for storing control information for use in recording information, which program is operative to cause a processor to perform the method as claimed in claim 12.
